(19) United States
(12) Patent Application Publication
(10) Pub. No.: US 2012/0066040 A1
(43) Pub. Date: Mar. 15, 2012

(54) VIRTUAL-WORLD BENEFIT TO MOTIVATE PHYSICAL-WORLD PURCHASE

(75) Inventors: Eric J. Farraro, San Jose, CA (US); John Tapley, Santa Clara, CA (US)

(73) Assignee: eBay Inc., San Jose, CA (US)

(21) Appl. No.: 12/883,042

(22) Filed: Sep. 15, 2010

(51) Int. Cl. G06Q 30/00

(52) U.S. Cl. 705/14.12; 705/14.1; 705/14.17

(57) ABSTRACT

A virtual-world benefit may be used to motivate a physical-world purchase. A game machine presents a suggestion that a user (e.g., a player of a game hosted by the game machine) make a purchase of physical-world item, and the suggestion includes an indication that the purchase entitles the user to the virtual-world benefit, thus providing the user with an incentive to make the purchase of the physical-world item. The virtual-world benefit may include a virtual world item, an amount of virtual-world currency, or both. Supposing that the user makes the purchase, the game machine accesses purchase data of the physical-world item. The purchase data indicates that the user has made the purchase. Based on the purchase data, the game machine changes a data structure of the user. The data structure is accessible by a process that configures the virtual environment as including the virtual-world benefit.

### TECHNICAL FIELD

The subject matter disclosed herein generally relates to the processing of data. Specifically, the present disclosure addresses systems and methods of utilizing a virtual-world benefit to motivate a physical-world purchase.

### BACKGROUND

A “virtual world” is a non-physical environment. Accordingly, a virtual world is physically intangible. A virtual world may be generated by one or more machines as a machine-generated virtual environment. The virtual world may include one or more virtual-world items that are manipulable within the machine-generated virtual environment. For example, the virtual world may be a chessboard environment within a chess game (e.g., rendered in two dimensions or in three dimensions), and the chessboard environment may include a virtual chess piece (e.g., a representation of a black queen) as a virtual-world item. As another example, several game servers may generate a network-based adventure game in which players access the game using game client machines and are represented by avatars. Within the game, these avatars may manipulate one or more weapons, tools, prizes, or other virtual-world objects as virtual-world items.

A virtual world may be described in contrast to the “physical world,” which is not generated by any machine and includes physical-world items that are physically tangible and manipulable in the physical world. For example, a human being exists in the physical world, regardless of any interaction with any virtual world, or lack thereof. Physical-world items may include the human being's clothing (e.g., a shoe), a physically tangible chess piece (e.g., a black queen made of teak wood), and a machine that is able to generate a virtual-world.

### BRIEF DESCRIPTION OF THE DRAWINGS

Some embodiments are illustrated by way of example and not limitation in the figures of the accompanying drawings in which:

FIG. 1 is a conceptual diagram of a physical-world purchase resulting in a virtual-world benefit, according to some example embodiments;

FIG. 2 is a diagram illustrating a data structure being changed to include one or more portions of the virtual-world benefit, according some example embodiments;

FIG. 3 is a network diagram illustrating a network environment suitable for utilizing a virtual-world benefit to motivate a physical-world purchase, according to some example embodiments;

FIG. 4 is a flowchart illustrating a method of utilizing a virtual-world benefit to motivate a physical-world purchase, according to some example embodiments;

FIG. 5 is a block diagram illustrating components of a game machine, according to some example embodiments;

FIG. 6-7 are flowcharts illustrating operations in a method of utilizing a virtual-world benefit to motivate a physical-world purchase, according to some example embodiments; and

FIG. 8 is a block diagram illustrating components of a machine, according to some example embodiments, able to read instructions from a machine-readable medium and perform any one or more of the methodologies discussed herein.

### DETAILED DESCRIPTION

Example methods and systems are directed to utilizing a virtual-world benefit to motivate a physical-world purchase. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In the physical world, a physical-world item may be purchased using physical-world currency. Specifically, a purchaser in the physical world may exchange an amount of physical-world currency for the physical-world item. In greater detail, the purchaser may provide the amount of physical-world currency to a seller of the physical-world item, and the seller may respond by providing the purchaser with an entitlement to the physical-world item. The physical-world currency is a medium of exchange that is valid in the real world and may not be valid in a virtual world. The physical-world currency is declared as legal tender by a government (e.g., the government of the United States) and may be listed in an internationally recognized standard (e.g., International Organization for Standardization (ISO) 4217).

Similarly, in a virtual world, a virtual-world item may be purchased using virtual-world currency. In particular, a purchaser in the real world may exchange an amount of virtual-world currency for the virtual-world item. For example, the virtual world may be generated by a machine, and the purchaser may interact with the virtual world using a user interface of a client device to communicate with the machine and provide the amount of virtual-world currency to a seller of the virtual-world item. The seller may respond by providing the purchaser with an entitlement to the virtual-world item. The virtual-world currency is a medium of exchange that is valid in the virtual world and may not be valid in the real world. The virtual-world currency may not be declared as legal tender by any government (e.g., the government of the United States) and may not be listed in any internationally recognized standard (e.g., ISO 4217).

A virtual-world benefit may be used to motivate a physical-world purchase. For example, a game machine may present a suggestion that a user make a purchase of a physical-world item, and the suggestion may include an indication that the purchase, once made, entitles the user to the virtual-world benefit, thus providing the user with an incentive to make the purchase of the physical-world item. The user may be a player of a game hosted by the game machine, although the user need not be playing the game at the time the suggestion is presented. Moreover, although a game machine is discussed herein, the game machine is merely an example of a machine that generates a non-physical virtual environment, and any such machine may apply one or more of the methodologies discussed herein (e.g., a training simulation machine).

The virtual-world benefit may include a virtual world item, an amount of virtual-world currency, or both. Supposing that the user makes the purchase of the physical-world item, the game machine may access purchase data of the physical-world item (e.g., purchase confirmation data), where the purchase data indicates that the user has made the purchase. Based on the purchase data (e.g., in response to accessing the purchase data), the game machine may provide the virtual-world benefit to the user.

Provision of the virtual-world benefit may include changing a data structure of the user in response to the purchase data. The data structure may represent an inventory of the user (e.g., a list of virtual-world items owned), an account of the user (e.g., a quantity of virtual-world currency), or both, within the virtual world. As such, the data structure may be used to configure at least a portion of the virtual world as including the virtual-world benefit (e.g., a virtual garage, or a virtual bank account). According to various example embodiments, the data structure is accessible by a process that is executable to configure the virtual world (e.g., as including the virtual-world benefit).

As a result, the user gains both the physical-world item and the virtual-world benefit, in exchange for an amount of physical-world currency used to purchase the physical-world item. The virtual-world benefit need not be related to the physical-world item. For example, the virtual-world benefit may be 10 extra lives within a game that is set within the virtual world. In some example embodiments, however, the virtual-world benefit includes a virtual-world item that is related to the physical-world item. For example, the user may purchase a physical-world car (e.g., a low-end model, like a real Honda CR-Z) and may receive a virtual-world car as the virtual-world benefit (e.g., a high-end model, like a virtual Porsche 911 Carrera). In certain example embodiments, the virtual-world benefit includes some virtual-world currency to accompany the virtual-world item (e.g., 1000 virtual gold coins), which may be used by the user to customize or upgrade the virtual-world item (e.g., add a rear spoiler). In some example embodiments, the virtual-world currency is tradable for a virtual-world item (e.g., virtual paint or decals).

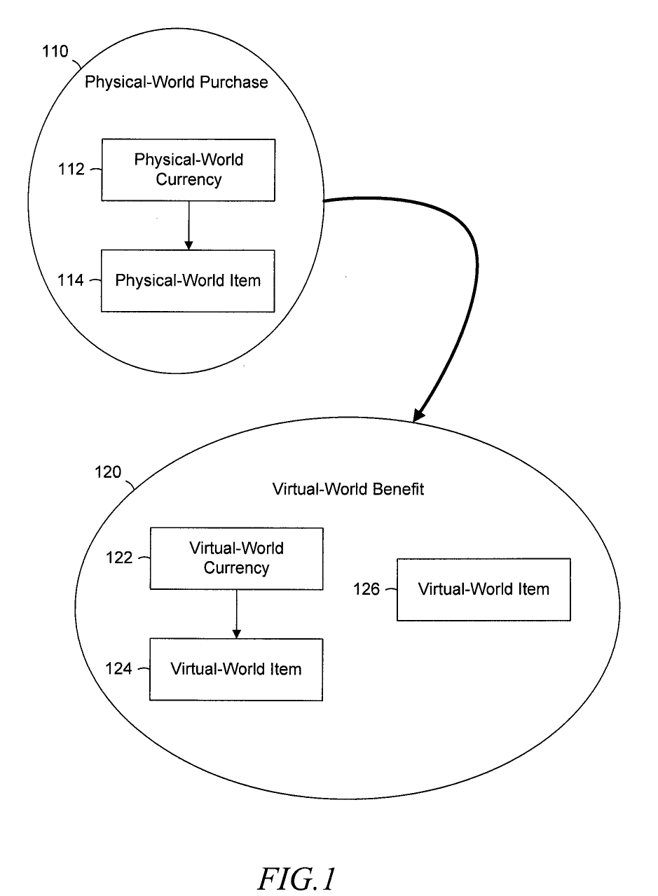

FIG. 1 is a conceptual diagram of a physical-world purchase 110 resulting in a virtual-world benefit 120 being provided to a user, according to some example embodiments. From the perspective of the user, an amount of physical-world currency 112 is exchanged for a physical-world item 114. This exchange constitutes the physical-world purchase 110.

As a result of the physical-world purchase 110, the user is entitled to (e.g., receives or is provided with) the virtual-world benefit 120. The virtual-world benefit 120 may include a virtual-world item 126. In some example embodiments, the virtual-world item 126 is related to the physical-world item 114. For example, the physical-world item 114 may be a real car in the real world, and the virtual-world item 126 may be a virtual car in a virtual world (e.g., identical to, similar to, or unrelated to the real car in the real world). In certain example embodiments, the virtual-world item 126 is related to the amount of physical-world currency 112. For example, the amount of physical-world currency 112 may be $25 in U.S. dollars, and the virtual-world item 126 may be a virtual motorcycle in the virtual world (e.g., advertised as a promotional item for users who have spent at least $25 on purchases within the physical world, the virtual world, or both).

The virtual-world benefit 120 may include an amount of virtual-world currency 122. The amount of virtual-world currency 122 may represent an amount of virtual money, a stored value (e.g., of points, miles, or credits), or any suitable combination thereof. The amount of virtual-world currency 122 may be exchangeable for a virtual-world item 124 (e.g., a further virtual-world item), for example, by the user making a further purchase that exchanges the amount of virtual-world currency 122 for the virtual-world item 124.

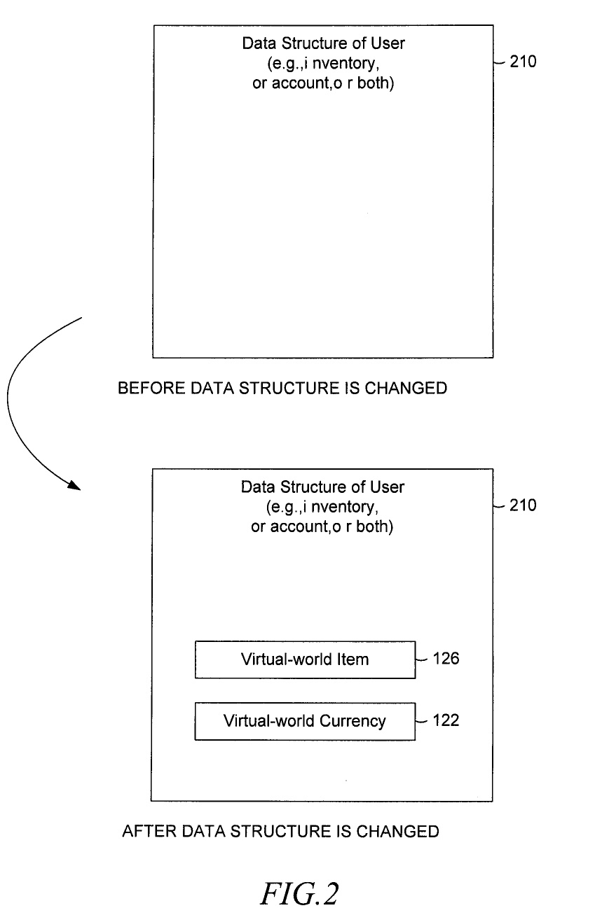

FIG. 2 is a diagram illustrating a data structure 210 being changed to include the virtual-world item 126 and the amount of virtual-world currency 122, according some example embodiments. The data structure 210 corresponds to a user (e.g., a player of a game that is set in the virtual world) and may be stored in a database (e.g., a database storing configuration information for the game, or a database storing account information for the user). The game machine may provide the virtual-world benefit 120 to user by changing the data structure 210, for example, as shown in FIG. 2. When accessed by a process (e.g., a virtual-world generation process) that is executable to configure the machine-generated virtual environment (e.g., the virtual world), the data structure 210 may cause the process to configure the machine-generated virtual environment as including the virtual-world benefit 120. This may have the effect of providing the virtual-world benefit 120 to the user, as perceived by the user.

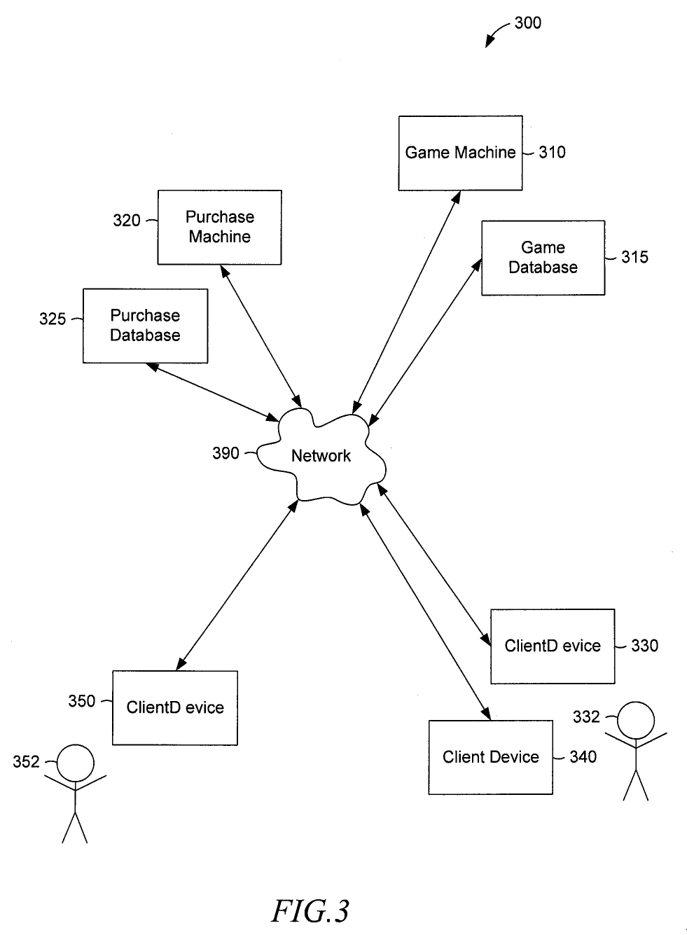

FIG. 3 is a network diagram illustrating a network environment 300 suitable for utilizing a virtual-world benefit to motivate a physical-world purchase, according to some example embodiments. The network environment 300 includes a game machine 310, a game database 315, a purchase machine 320, a purchase database 325, and client devices 330, 340, and 350, all communicatively coupled to each other via a network 390.

The game machine 310 may be a game server that hosts a network-based game. The game may be set in a virtual world that is generated by the game machine 310. The virtual world may support virtual-world items and may support a virtual-world currency. The game machine 310, in functioning as a game server, may utilize a virtual-world benefit to motivate a physical-world purchase. The game database 315 may store data pertinent to the game. For example, the game database 315 may store a current status (e.g., state) of the game, a current status of one or more users (e.g., players) of the game, or both. The status of a user may include a score, a list of attained achievements, an inventory of virtual-world items, a stored value of virtual-world currency, a set of user preferences, a user profile, or any suitable combination thereof. As an example, the data structure 210 may be stored by the game database 315. In some example embodiments, the data structure 210 may be stored by the purchase database 325.

The purchase machine 320 may form all or part of a network-based purchasing system, a network-based publication system, a network-based merchandising system, or any suitable combination thereof. For example, the purchase machine 320 may be a shopping server, an electronic storefront, an online auction website, or a classified ad server. The purchase machine 320 facilitates one or more physical-world purchases (e.g., physical-world purchases motivated by utilization of one or more virtual-world benefits). The purchase database 325 may store data pertinent to one or more of such purchases. For example, the purchase database 325 may store purchase data that indicates a purchase of a physical-world item (e.g., purchase confirmation data, a date of the purchase, an identifier of a purchaser that made the purchase, an amount of physical-world currency used to make the purchase, or a title of the physical-world item). The purchase machine 320 may make the purchase data in the purchase database 325 accessible to the game machine 310 via the network 390; alternatively, the purchase database 325 may directly make the purchase data accessible to the game machine 310 (e.g., via the network 390).

Also shown in FIG. 3 are users 332 and 352. One or both of the users 332 and 352 may be a human user (e.g., a human being), a machine user (e.g., software program to interact with a client device), or any suitable combination thereof. The user 332 is not part of the network environment 300, but is associated with the client devices 330 and 340 and may be a user of the client devices 330 and 340. For example, the client device 330 may be a deskside computer belonging to the user 332, and the client device 340 may be a tablet computer or a smart phone belonging to the user 332. Similarly, the user 352 is not part of the network environment 300, but is associated with the client device 350. As an example, the client device 350 may be a tablet computer belonging to the user 352.

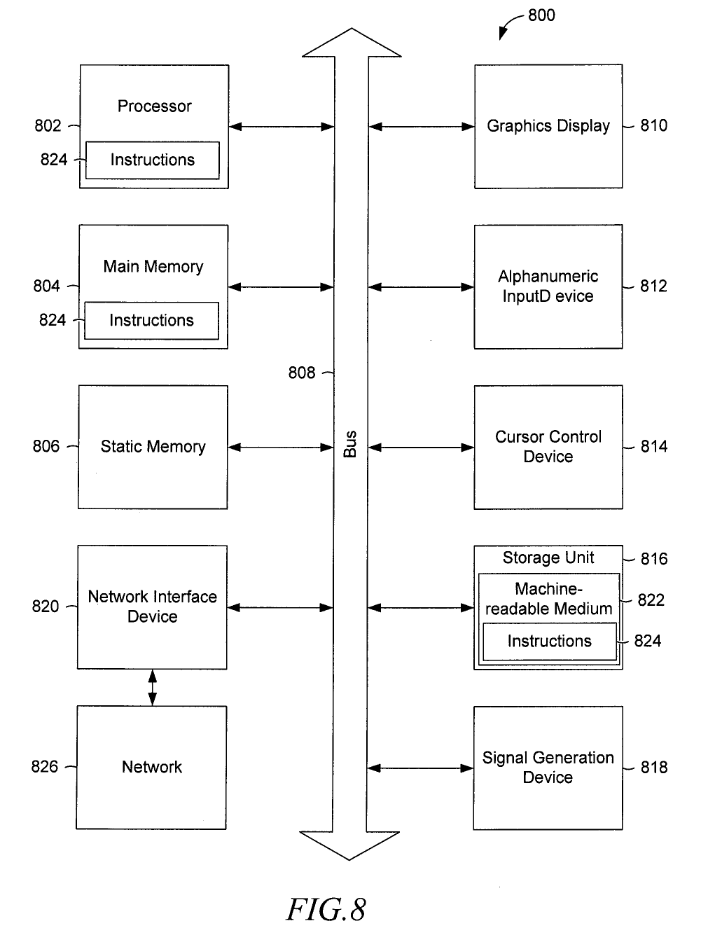

Any of the machines, databases, or devices shown in FIG. 3 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 8. As used herein, a “database” is a data storage resource and may store data structured as a text file, a table, a spreadsheet, a relational database, a triple store, or any suitable combination thereof. Moreover, any two or more of the machines illustrated in FIG. 3 may be combined into a single machine, and the functions described herein for any single machine may be subdivided among multiple machines.

The network 390 may be any network that enables communication between machines (e.g., game machine 310 and purchase machine 320). Accordingly, the network 390 may be a wired network, a wireless network, or any suitable combination thereof. The network 390 may include one or more portions that constitute a private network, a public network (e.g., the Internet), or any suitable combination thereof.

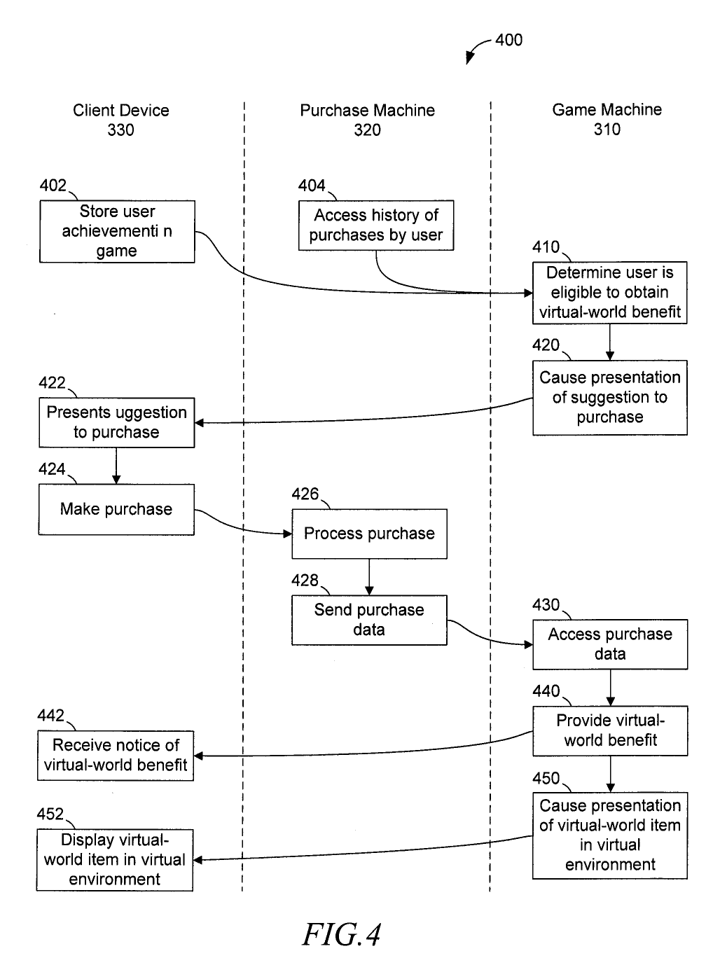

FIG. 4 is a flowchart illustrating a method 400 of utilizing the virtual-world benefit 120 to motivate the physical-world purchase 110, according to some example embodiments. In the examples shown, the method 400 is performed using the game machine 310, the purchase machine 320, and the client device 330.

The game machine 310 hosts a game that is playable by the user 332 using the client device 330, and the user 332 has attained an achievement (e.g., a user achievement) in the game. In operation 402, the client device 330 stores the user achievement (e.g., at the game machine 310, in the game database 315, or on the client device 330). Operation 402 may be performed by the client device 330 in response to the user 332 attaining the achievement.

In operation 404, the purchase machine 320 accesses a history of purchases made by the user 332. The history of purchases may be a record of physical-world purchases of physical-world items that had been purchased by the user 332. Such a record may be limited to physical-world purchases made using the purchase machine 320 or may include information from physical-world purchases made using external purchasing systems (e.g., a third-party network-based commerce system). In some example embodiments, the history of purchases may include information on attempted purchases (e.g., bids placed on items at auction), indications of interest in a physical-world item (e.g., submitted search terms or requested page views), or any suitable combination thereof Operation 404 may be performed by the purchase machine 320 in response to a request by the game machine 310. The request may be a repeating request sent periodically from the game machine 310. In some example embodiments, the request is sent via the game machine 310 in response to an activity by the user 332 within the virtual-world of the game (e.g., starting a new game or completing a training exercise for novice players).

In operation 410, the game machine 310 determines that the user 332 is eligible to obtain the virtual-world benefit 120 (e.g., upon making the physical-world purchase 110). The game machine 310 may make this determination based on the user achievement stored in operation 402, the history of purchases accessed in operation 404, or both.

In operation 420, the game machine 310 causes a presentation of a suggestion that the user 332 make the physical-world purchase 110 of the physical-world item 114 with the amount of physical-world currency 112. For example, the game machine 310 may prompt the client device 330 to present the suggestion. The suggestion includes an indication that the physical-world purchase 110 entitles the user 332 to the virtual-world benefit 120, which includes the virtual-world item 126. The presenting of the suggestion may be direct (e.g., displaying a message or sounding an alert from the game machine 310) or indirect (e.g., causing the client device 330 to display a message or sound alert). Accordingly, operation 420 may include transmitting the suggestion to the client device 330 for presentation by the client device 330.

In operation 422, the client device 330 presents the suggestion discussed above with respect to operation 420. The client device 330 may receive the suggestion and then display the suggestion to the user 332 (e.g., using a display screen of the client device 330). Supposing that the user 332 is motivated (e.g., by the virtual-world benefit 120 or by a pre-existing plan or desire) to make the physical-world purchase 110, the client device 330 may be used in operation 424 to make the physical-world purchase 110. For example, the client device 330 may facilitate an online transaction (e.g., an online shopping transaction) to perform the physical-world purchase 110.

In operation 426, the purchase machine 320 processes the physical-world purchase 110. For example, the purchase machine 320 may initiate an online transaction (e.g., an online shopping transaction) that exchanges the amount of physical-world currency 112, on behalf of the user 332, for an entitlement to the physical-world item 114 to benefit the user 332.

In operation 428, the purchase machine 320 sends purchase data to the game machine 310. The purchase data confirms the physical-world purchase 110 and indicates that the user 332 has made the purchase of the physical-world item 114 with physical-world currency 112. In some example embodiments, the purchase data includes a reference to the suggestion discussed above with respect to operation 410, thus indicating that the physical-world purchase 110 corresponds to the suggestion. This may have the effect of providing a confirmation that the physical-world purchase 110 was motivated by the virtual-world benefit 120, which is mentioned in the suggestion.

In operation 430, the game machine 310 accesses the purchase data sent in operation 428. For example, the game machine 310 may read the purchase data from a memory, from a network interface device, or any suitable combination thereof.

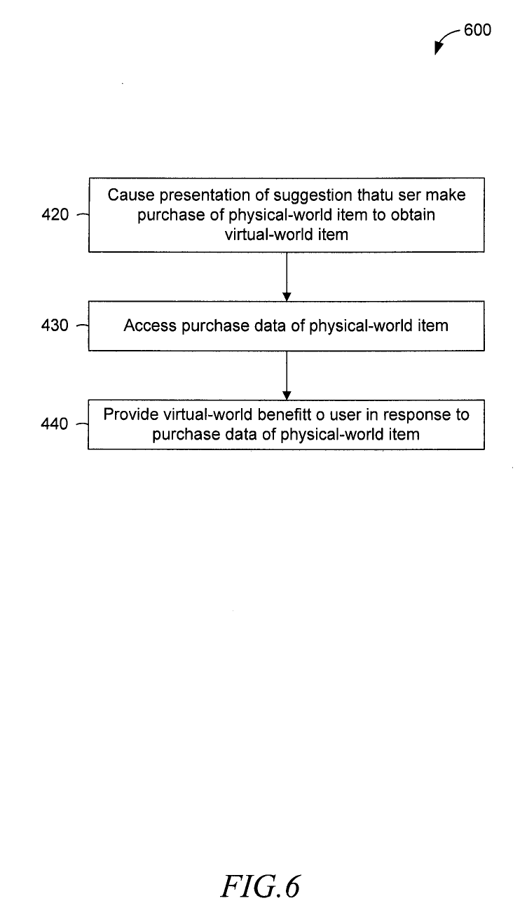

In operation 440, the game machine 310 provides the virtual-world benefit 120 to the user 332. As noted above, provision of the virtual-world benefit 120 to the user 332 may include changing a data structure (e.g., data structure 210) that is used to fully or partially configure the virtual world (e.g., an inventory or an account within the virtual world). Operation 440 may be performed based on (e.g., in response to) the purchase data accessed in operation 430. Further details of operation 440 are discussed below with respect to FIG. 6.

In operation 442, the client device 330 receives notice that the virtual-world benefit 120 has been provided to the user 332 in operation 440. In response, the client device 330 may notify the user 332 (e.g., display a message or sound an alert) of entitlement to the virtual world benefit 120.

In operation 450, the game machine 310 causes a presentation of the virtual-world item 126 in the virtual environment of the game that is hosted by the game machine 310. For example, the game machine 310 may prompt the client device 330 to present the virtual-world item 126. The presenting of the virtual-world item 126 may be direct (e.g., using visual or auditory information from the game machine 310) or indirect (e.g., causing the client device 330 to use visual or auditory information to present the virtual-world item 126). For example, the game machine 310 may display the virtual-world item 126 in a portion of the virtual environment (e.g., an inventory list, a player console, or a view among multiple views of the virtual environment). As another example, the game machine 310 may cause the client device to perform such a display of the virtual-world item 126, as shown in operation 452.

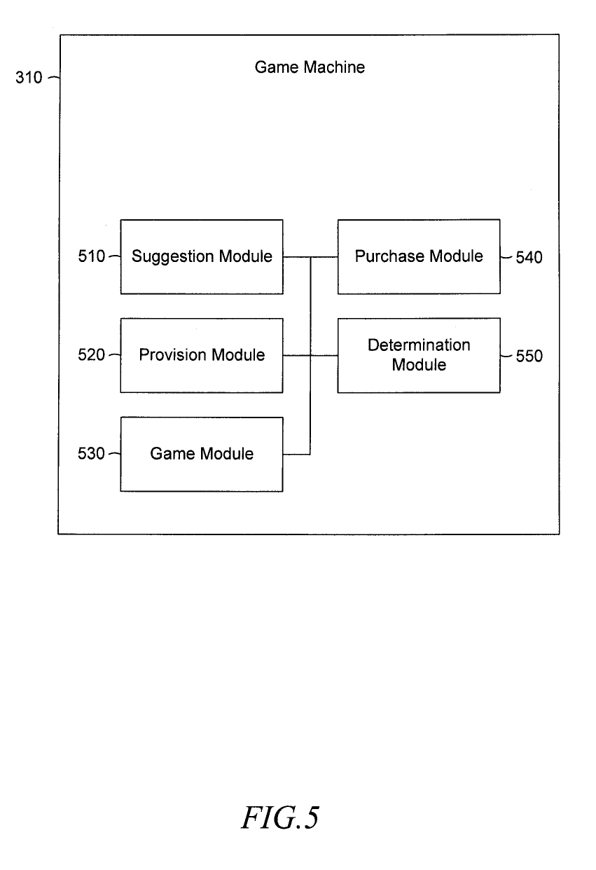

FIG. 5 is a block diagram illustrating components of the game machine 310, according to some example embodiments. The game machine 310 includes a suggestion module 510, a provision module 520, a game module 530, a purchase module 540, and a determination module 550, all configured to communicate with each other (e.g., via a bus, a shared memory, or a switch). Any one or more of these modules may be implemented using hardware (e.g., a processor of a machine) or a combination of hardware and software. Moreover, any two or more of these modules may be combined into a single module, and the functions described herein for a single module may be subdivided among multiple modules.

The suggestion module 510 is configured to present the suggestion that the user 332 make the physical-world purchase 110 of the physical-world item 114 with the amount of physical-world currency 112. As noted above, the suggestion includes an indication that the physical-world purchase 110 entitles the user 332 to the virtual-world benefit 120, which includes the virtual-world item 126. Moreover, the presenting of the suggestion may be direct (e.g., to the user 332) or indirect (e.g., to the user 332 via the client device 330). The suggestion module 510 may communicate the suggestion to the client device 330.

The provision module 520 is configured to access purchase data of the physical-world item 114 (e.g., from a memory, the purchase machine 320, or the purchase database 325). As noted above, the purchase data indicates that the user 332 made the purchase of the physical-world item 114 (e.g., the physical-world purchase 110). The purchase data may include a reference to the suggestion presented by the suggestion module 510.

The provision module 520 is further configured to provide the virtual-world benefit 120 to the user 332. The provision of the virtual-world benefit 120 may be based on the purchase data accessed by the provision module 520 and may be in response to the purchase data.

In providing the virtual-world benefit 120, the provision module 520 may update an inventory of the user 332 (e.g., a list of virtual-world items belonging to the user 332). The updating of the inventory may be based on the virtual-world item 126. For example, the inventory may be updated to include the virtual-world item 126 or a representative identifier thereof (e.g., an icon, a title, a description, a serial number, or a nickname). The updated inventory may specify that the virtual-world item 126 corresponds to the user 332 (e.g., belongs to the user 332).

According to some example embodiments, the provision module 520 may increment an account of the user 332 (e.g., when providing the virtual-world benefit 120). The account of the user 332 may be incremented by the amount of virtual-world currency 122. As noted above, the amount of virtual-world currency 122 may be exchangeable for a virtual-world item (e.g., a further virtual-world item) within the virtual environment generated by the game machine 310.

The game module 530 is configured to manage the game hosted by the game machine 310. The game module 530 may generate the virtual environment of the game and may communicate with the game database 315 to maintain one or more statuses pertinent to the game (e.g., game status or player status of the user 332).

The game module 530 may be further configured to present at least a portion of the virtual environment to the user 332. The presenting of the portion may be based on the inventory of the user 332 (e.g., updated to specify that the virtual-world item 126 corresponds to the user 332).

The purchase module 540 is configured to access a history of purchases made by the user 332. As noted above, the history of purchases may be a record of physical-world purchases of physical-world items that had been purchased by the user 332. The history of purchases may be stored in purchase machine 320, the purchase database 325, or both. The purchase module 540 may access the history of purchases by accessing a memory, the purchase machine 320, the purchase database 325, or any suitable combination thereof.

The determination module 550 is configured to make various determinations that facilitate utilizing the virtual-world benefit 120 to motivate the physical-world purchase 110. In particular, the virtual-world item 126 may be selected from a set of available virtual-world items that are supported by the game module 530. The determination module 550 may determine the virtual-world item 126 based on the amount of physical-world currency 112. For example, the virtual-world item 126 may be a virtual car that corresponds to the amount of physical-world currency 112 spent in making the physical-world purchase 110 (e.g., $100 in U.S. dollars).

Moreover, the determination module 550 may determine the virtual-world item 126 based on the physical-world item 114. For example, the virtual-world item 126 may be an article of virtual clothing that looks similar to a corresponding article of real clothing (e.g., a blue denim jacket).

Furthermore, the determination module 550 may identify a category of the physical-world item 114. As an example, supposing the physical-world item 114 is a blue denim jacket, the determination module may identify the category as being “outerwear.” Having determined the category, the determination module 550 may determine the virtual-world item 126 based on the category. Continuing the example, where the category is identified to be “outerwear,” the determination module 550 may select a virtual yellow raincoat as the virtual-world item 126, based on the virtual yellow raincoat corresponding to the category “outerwear.” In some example embodiments, the category of the physical-world item 114 is a physical-world category (e.g., “real outerwear”), and virtual-world item 126 is selected from a virtual category (e.g., “virtual outerwear”) that corresponds to the physical-world category. Correspondence relationships between or among real categories and virtual categories may be stored in the game database 315.

According to various example embodiments, the virtual-world benefit 120 includes the amount of virtual-world currency 122. The determination module 550 may determine the amount of virtual-world currency 122. This determination may be based on the amount of physical-world currency 112, the physical-world item 114, the virtual-world item 126, or any suitable combination thereof. For example, the determination module 550 may implement a promotion that provides 1000 virtual gold coins for making a purchase worth at least $100 in U.S. dollars. As another example, the promotion may provide 1000 game points for making a purchase of a particular brand and model of electronic coffee maker. As a further example, the determination module 550 may implement a policy that provides an amount of virtual money to accessorize the virtual-world item 126 (e.g., a virtual motorcycle).

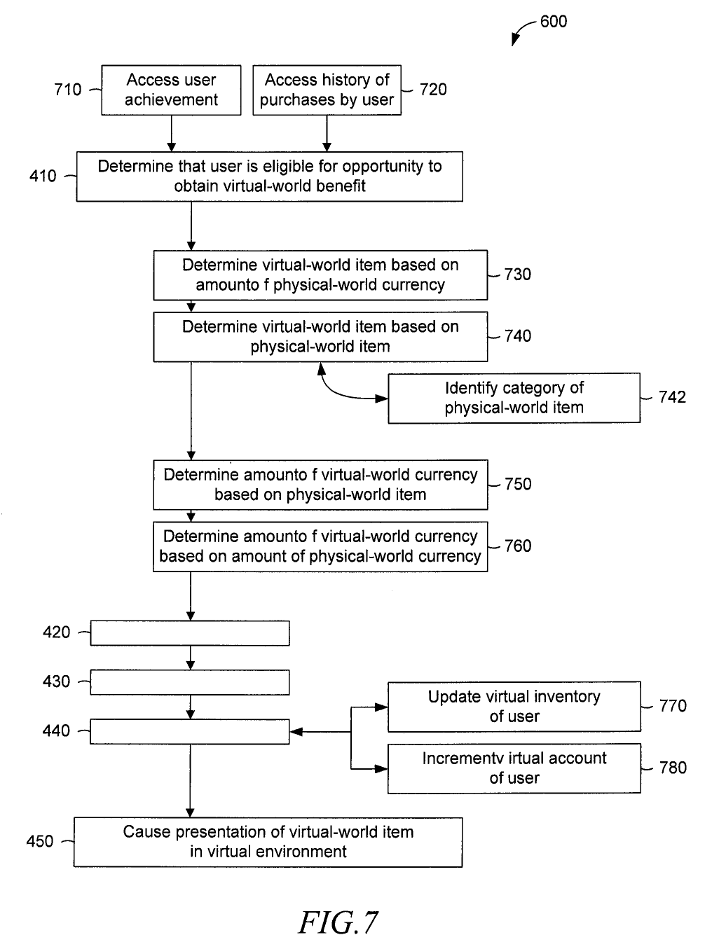

FIG. 6-7 are flowcharts illustrating operations in a method 600 of utilizing the virtual-world benefit 120 to motivate the physical-world purchase 110, according to some example embodiments. Operations in the method 600 may be performed by the game machine 310, using modules described above with respect to FIG. 5.

As shown in FIG. 6, some embodiments of the method 600 include operations 420, 430, and 440, briefly described above with respect to FIG. 4. In operation 420, the suggestion module 510 causes the presentation of the suggestion that the user 332 make the physical-world purchase 110 of the physical-world item 114 (e.g., a real digital camera) with the amount of physical-world currency 112 (e.g., $300 in U.S. dollars). As noted above, the suggestion includes an indication that the physical-world purchase 110 entitles the user 332 to the virtual-world benefit 120, which includes the virtual-world item 126 (e.g., a virtual pair of conga drums).

In operation 430, the provision module 520 accesses the purchase data of the physical-world item 114 (e.g., purchase confirmation data of the physical-world purchase 110). As noted above, the purchase data indicates that the user 332 has made the physical-world purchase 110 and may include a reference to the suggestion discussed above with respect to operation 420.

In operation 440, the provision module 520 provides the virtual-world benefit 120 to the user 332. As noted above, provision of the virtual-world benefit 120 to the user may include changing the data structure 210, which may be used to fully or partially configure the virtual world (e.g., an inventory or an account of the user 332). Provision of the virtual-world benefit 120 may be in response to the purchase data accessed in operation 440.

As shown in FIG. 7, some embodiments of the method 600 include operations 710-780. In operation 710, the game module 530 accesses a user achievement that has been attained within the game hosted by the game machine 310. The user achievement may be stored in the game database 315, the client device 330, or both. For example, the user 332 may be a player of the game and may have attained a minimum threshold score (e.g., 1,000,000 game points) as the user achievement. This user achievement may be at least a partial basis for later determining that the user 332 is eligible to obtain the virtual-world benefit 120.

In operation 720, the game module 530 accesses the history of purchases made by the user 332. The history of purchases may be stored by the purchase machine 320, the purchase database 325, the game machine 310, the game database 315, the client device 330, or any suitable combination thereof. For example, the user 332 may have previously purchased a minimum threshold quantity of goods (e.g., 50 cases of diapers) as a purchasing achievement. This purchasing achievement may be at least a partial basis for later determining that the user 332 is eligible to obtain the virtual-world benefit 120.

In operation 410, the determination module 550 determines that the user 332 is eligible for an opportunity to obtain the virtual-world benefit 120. This determination may be based on the user achievement accessed in operation 710, the purchasing achievement stored in the history of purchases accessed in operation 720, or any suitable combination thereof This may have the effect of selecting the user 332 from among multiple users (e.g., players) of the game machine 310 as being eligible for the virtual-world benefit 120, the virtual-world item 126, or both.

In operation 730, the determination module 550 determines the virtual-world item 126 based on the amount of physical-world currency 112, as described above with respect to FIG. 5. In operation 740, the determination module 550 determines the virtual-world item 126 based on the physical-world item 114, as described above. Operation 740 may include operation 742, which involves identifying a category of the physical-world item 114, and the category may form at least a partial basis for determining the virtual-world item 126. Moreover, operations 730 and 740 may be combined into a hybrid operation that determines the virtual-world item 126 based on the amount of physical-world currency 112, the physical-world item 114, the category of the physical-world item 114, or any suitable combination thereof.

According to certain example embodiments, the virtual-world benefit 120 includes the amount of virtual-world currency 122. In operation 750, the determination module 550 determines the amount of virtual world currency 122 based on the physical-world item 114. In operation 760, the determination module 550 determines the amount of virtual-world currency 122 based on the amount of physical-world currency 112. Some example embodiments of the method 600 combine operations 750 and 760 into a hybrid operation that determines the amount of virtual-world currency 122 based on the physical-world item 114, the amount of physical-world currency 112, or any suitable combination thereof

As shown in FIG. 7, operation 440 may include operation 770, operation 780, or both. In operation 770, the provision module 520 updates a virtual inventory (e.g., in the game hosted by the game machine 310) of the user 332. As noted above with respect to FIG. 5, the updating of the inventory may be based on the virtual-world item 126. Moreover, the updated inventory may specify that the virtual-world item 126 corresponds to the user 332 (e.g., belongs to the user 332).

In operation 780, the provision module 520 increments an account of the user 332. The account may be a stored value account, a virtual account, or any suitable combination thereof The account may function as a virtual repository for virtual-world currency that corresponds to (e.g., belongs to) the user 332. Accordingly, the account of the user 332 may be incremented by the amount of virtual-world currency 122, in operation 780.

Operation 450, in certain example embodiments, follows operation 440. In operation 450, the game module 530 causes a presentation of at least a portion of the machine-generated virtual environment of the game that is hosted by the game machine 310. For example, the game module 530 may prompt the client device 330 to present at least a portion of the machine-generated virtual environment. The portion of the virtual environment may be presented to the user 332, and as noted above, presentation of the portion may be direct to the user 332 or indirect via an intermediary device (e.g., client device 330). The presenting of the portion may be based on the virtual inventory updated in operation 770, and the portion of the virtual environment may depict (e.g., by inclusion within the portion) the virtual-world item 126 (e.g., the virtual pair of conga drums).

According to various example embodiments, one or more of the methodologies described herein may facilitate utilization of a virtual-world benefit to motivate a physical-world purchase. In particular, one or more of the methodologies described herein may constitute all or part of a business method (e.g., a business method implemented using a machine) that provides users of a network-based system with incentives to make purchases. For example, a physical-world product offered for sale on a network-based commerce system may be merchandised by incorporating the physical-world product or physical-world specimens thereof into suggestions for purchase (e.g., as the physical-world item 114). Accordingly, one or more of the methodologies described herein may have the effect of increasing sales of a product, increasing user attention (e.g., as measured in page views or clickthroughs) on the product, or both. Moreover, one or more of the methodologies described herein may provide users who are players of a game (e.g., hosted by the game machine 310) with incentives to increase their time or effort spent playing the game. This may have the indirect effect of merchandising further products or specimens thereof, for example, as a result of increased page views, advertisement views, exposure to promotions of further physical-world items, or any suitable combination thereof.

When these effects are considered in aggregate, one or more of the methodologies described herein may obviate a need for certain efforts or resources that otherwise would be involved in matching users (e.g., as potential purchasers) with products or specimens thereof that are likely to be of interest. Efforts expended by a user in identifying a product for purchase may be reduced by one or more of the methodologies described herein. Computing resources used by one or more machines, databases, or devices (e.g., within the network environment 300) may similarly be reduced. Examples of such computing resources include processor cycles, network traffic, memory usage, data storage capacity, power consumption, and cooling capacity.

FIG. 8 illustrates components of a machine 800, according to some example embodiments, that is able to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software) for causing the machine 800 to perform any one or more of the methodologies discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824 (sequentially or otherwise) that specify actions to be taken by that machine. Execution of the instructions 824 at any particular point may be single-threaded or multi-threaded. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 (e.g., network 390) via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., software) for execution by the machine, such that the instructions, when executed by one or more processors of the machine (e.g., processor 802), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
causing a presentation of a suggestion that a user make a purchase of a physical-world item with an amount of physical-world currency, the physical-world item being a physically tangible good, the physical-world currency being declared as legal tender by a government,
the suggestion including an indication that the purchase entitles the user to a virtual-world benefit that includes a virtual-world item valid in a machine-generated virtual environment,
the virtual-world item being a physically intangible good that is manipulable in the machine-generated virtual environment,
the presenting being performed using a processor of a machine as configured by a module;
accessing purchase data of the physical-world item, the purchase data indicating that the user made the purchase of the physical-world item; and
changing a data structure of the user in response to the purchase data of the physical-world item,
the data structure being accessible by a process that is executable to configure the machine-generated virtual environment as including the virtual-world benefit.

2. The method of claim 1, wherein:
the data structure is representative of an inventory of the user; and
the changing of the data structure updates the inventory of the user based on the virtual-world item, the updated inventory of the user specifying that the virtual-world item corresponds to the user.

3. The method of claim 2 further comprising:
causing a presentation of at least a portion of the machine-generated virtual environment to the user based on the updated inventory of the user, the portion depicting the virtual-world item.

4. The method of claim 1 further comprising:
determining the virtual-world item based on the amount of physical-world currency.

5. The method of claim 1 further comprising:
determining the virtual-world item based on the physical-world item.

6. The method of claim 5 further comprising:
identifying a category of the physical-world item, the category being indicative of a set of physical-world items that includes the physical-world item; and wherein
the determining of the virtual-world item is based on the identified category of the physical-world item.

7. The method of claim 1, wherein:
the physical-world currency is listed in International Organization for Standardization (ISO) 4217.

8. The method of claim 1, wherein:
the virtual-world benefit includes an amount of virtual-world currency that is usable as a medium of exchange in the machine-generated virtual environment, the virtual-world currency being not declared as legal tender by any government.

9. The method of claim 8, wherein:
the virtual-world currency is absent from International Organization for Standardization (ISO) 4217; and
a quantity of the virtual-world currency is exchangeable for a further virtual-world item within the machine-generated virtual environment, the further virtual-world item being a further physically intangible good that is manipulable in the machine-generated virtual environment.

10. The method of claim 8, wherein:
the data structure is representative of an account of the user; and
the changing of the data structure increments the account of the user by the amount of virtual-world currency, the account of the user specifying a quantity of the virtual-world currency, the quantity corresponding to the user.

11. The method of claim 8 further comprising:
determining the amount of virtual-world currency based on the amount of physical-world currency.

12. The method of claim 8 further comprising:
determining the amount of virtual-world currency based on the physical-world item.

13. The method of claim 1, wherein:
the purchase data indicates that purchase of the physical-world item was made using the amount of the physical-world currency.

14. The method of claim 1 further comprising:
determining that the user is eligible for an opportunity to obtain the virtual-world benefit; and wherein
the causing of the presentation of the suggestion is in response to the determining that the user is eligible.

15. The method of claim 14, wherein:
the determining that the user is eligible is based on a history of purchases made by the user.

16. The method of claim 14, wherein:
the determining that the user is eligible is based on an achievement attained by the user in playing a game that uses the machine-generated virtual environment.

17. The method of claim 1, wherein:
the purchase data includes a reference to the presented suggestion, the reference indicating that the purchase corresponds to the presented suggestion.

18. A system comprising:
a suggestion module implemented using a processor of a machine, the suggestion module being configured to cause a presentation of a suggestion that a user make a purchase of a physical-world item with an amount of physical-world currency,
the physical-world item being a physically tangible good, the physical-world currency being declared as legal tender by a government,
the suggestion including an indication that the purchase entitles the user to a virtual-world benefit that includes a virtual-world item valid in a machine-generated virtual environment,
the virtual-world item being a physically intangible good that is manipulable in the machine-generated virtual environment; and
a provision module configured to:
access purchase data of the physical-world item, the purchase data indicating that the user made the purchase of the physical-world item; and
change a data structure of the user in response to the purchase data of the physical-world item,
the data structure being accessible by a process that is executable to configure the machine-generated virtual environment as including the virtual-world benefit.

19. The system of claim 18, wherein:
the data structure is representative of an inventory of the user;
the provision module is configured to update the inventory of the user based on the virtual-world item, the updated inventory specifying that the virtual-world item corresponds to the user; and the system further comprises
a game module configured to:
determine that the user is eligible for an opportunity to obtain the virtual-world benefit based on an achievement attained by the user in playing a game that uses the machine-generated virtual environment; and
cause a presentation of at least a portion of the machine-generated virtual environment to the user based on the updated inventory of the user, the portion depicting the virtual-world item.

20. A non-transitory machine-readable storage medium comprising instructions that, when executed by one or more processors of a machine, cause the machine to perform operations comprising:
causing a presentation of a suggestion that a user make a purchase of a physical-world item with an amount of physical-world currency,
the physical-world item being a physically tangible good, the physical-world currency being declared as legal tender by a government,
the suggestion including an indication that the purchase entitles the user to a virtual-world benefit that includes a virtual-world item valid in a machine-generated virtual environment,
the virtual-world item being a physically intangible good that is manipulable in the machine-generated virtual environment;
accessing purchase data of the physical-world item,
the purchase data indicating that the user made the purchase of the physical-world item; and
changing a data structure of the user in response to the purchase data of the physical-world item,
the data structure being accessible by a process that is executable to configure the machine-generated virtual environment as including the virtual-world benefit.
